(19) United States
(12) Patent Application Publication
(10) Pub. No.: US 2005/0114570 A1
(43) Pub. Date: May 26, 2005

(54) Portable data storage device

(76) Inventors: Chi-Tung Chang, Taipei (TW); Hung-Chou Tsai, Nantou County (TW)

Correspondence Address: Chi-Tung Chang, 7F., No. 213, Civic Boulevard. Sec. 4, Taipei, 105, TW

(21) Appl. No.: 10/720,853

(22) Filed: Nov. 21, 2003

(51) Int. Cl. G06F 13/12

(52) U.S. Cl. 710/62

(57) ABSTRACT

A portable data storage device mainly includes a universal serial bus (USB) connector; a volatile memory for reading, writing, and storing data; a control chip connected between the USB connector and the volatile memory for serving as a transmission interface with an external electronic apparatus; a charging battery for providing power needed by the volatile memory to store data; and a battery charging circuit connected between the USB connector and the charging battery for charging the charging battery, so that the portable data storage device has increased data processing speed and may be produced at lowered cost.

### FIELD OF THE INVENTION

The present invention relates to a portable data storage device, and more particularly to a portable data storage device that uses a volatile memory to read, write, and access data.

### BACKGROUND OF THE INVENTION

With constant advancements in all kinds of technological fields, new computer-related products are introduced to the market at extremely quick speed, making computers more powerful to have wider and wider applications. For example, the capacity of hard disk has been developed from 10 MB in the early stage to the current 80 GB or even higher capacity with a growth rate as high as 800000% to store largely increased quantity of more detailed digital data.

Conventional data storage devices may be generally divided into two types. A first type of the conventional data storage devices is electronic solid-state memory, such as the read-only memory (ROM) and the random access memory (RAM). This type of memory is normally embedded in a computer and not independently portable.

The second type of the conventional data storage devices is surface-based data storage device, such as magnetic disk, compact disk, etc. This type of data storage device is portable for use at any place but requires a mechanical driving mechanism mounted or coupled to a computer, so that the computer is enabled to read data in the storage device. In addition, the combination of this type of data storage device with the mechanical driving mechanism thereof is usually bulky and requires a considerably long time to transmit data, and is therefore inconvenient for use.

Therefore, to send a file from one computer to another one in the early stage, the file in the first computer must be downloaded to a floppy disk, which is then read by the second computer to complete sending of the file between two computers. Since the floppy disk has a capacity of 1.44 MB, it could not be used to send a file larger than 1.5 MB. Currently, with the highly developed Internet, files may be conveniently sent from one computer to another one via emails. However, most users, particularly some business or technical representatives of many firms who might need to give a briefing at a client's office, would found it is impossible to send a briefing file about 10 MB to the client via email without paralyzing the client's email system. When the file is recorded on a compact disk, it would not be able to modify any part of the file. An alternative is to carry a heavy notebook computer for use at the client's meeting room. Even in this case, there might be the problem of, for example, having a power cord that is too short to use. What is worse is the image output from the notebook computer might not match the projector signal at the client's site, and a lot of noises are contained in the output image. All these latent factors would spoil the briefing. In conclusion, these troubles exist because there is not a portable plug-and-play data storage device suitable for storing such considerably large files for use at different places.

It is known the universal serial bus (USB) interface is currently a common interface adopted by most computers. The USB interface not only enables external input and output devices for existing high-power personal computers and workstations to be plug-and-play, but also have the following three advanced features:
1. It is easy to use through hot swapping and auto setting.
2. It has standardized contact and simplified connector.
3. It may be easily expanded through tiered star hub topology.

The currently available USB specifications include version 1.1 that has a maximum transmission speed of 12 Mbps, and version 2.0 that has a maximum transmission speed of 480 Mbps. USB 2.0 is first presented by Microsoft in WinHEC in April 2000, and its specification is established by USB Promoters Group. USB 2.0 upgrades the maximum data transmission speed of 12 Mbps of version 1.1 to 480 Mbps, and is compatible with the existing USB 1.1 product. USB 2.0 is small and compact and particularly suitable for use with both embedded and portable apparatuses. And, the high transmission speed and the large storage capacity make USB 2.0 particularly suitable for use with multi-media products. Plug and play is the best merit of USB. That is, USB automatically operates as soon as it is plugged to a computer, and is therefore very convenient for use. USB 2.0 is characterized in its downward compatibility. It has the same interface connector and wires as those for USB 1.1. Therefore, a peripheral using USB 1.1 may still operate well when it is connected to a computer using USB 2.0. In other words, a consumer having invested in other peripheral apparatus using USB 1.1 would not lose money when the computer mainframe uses USB 2.0 that provides higher data transmission speed. Therefore, there has been developed a portable memory associated with USB interface. The portable memory associated with USB interface uses a flash memory to read, write, and access data, and currently has a capacity as high as 512 MB or even 1 GB, which is more than enough for storing general big files. And, with the plug-and-play function of the USB, big files may be conveniently sent between two computers.

The storage unit for the flash memory is referred to as a cell. The metal oxide semiconductor (MOS) in the cell of the flash memory includes not only a traditional gate oxide, but also a float gate between its gate and channel. The existence of the float gate allows the flash memory to have three different operating modes, namely, read, write, and erase. When negative electrons are injected into the float gate, the cell is written from digit 1 to 0; and when the negative electrons are removed from the float gate, the cell is changed from 0 to 1, equivalent to the movement of erase.

There have been developed many techniques for injecting negative charges into the float gate or removing internally stored negative charges from the float gate, so that the flash memory is rewritable. Moreover, the flash memory may still keep the data stored in the cells when the power supply is interrupted. According to information from web sites of some flash memory manufacturers, the flash memory developed under the current highly advanced technologies has a read/write life about one hundred thousand times. Therefore, it is a very suitable solution for data storage by using the flash memory as a substitute for magnetic disks.

However, the electric charging and discharging feature of the flash memory also makes it have physical limits in the times of being read and written. The flash memory manufacturer could include in the internal firmware of the flash memory the function of counting each read and write of a flash memory block. When a specified high limit for the times of read and write has been reached, the block is marked as a non-usable zone. Therefore, it is very possible a flash memory card would have a capacity that gradually decreases when the flash memory card is extremely frequently used. Since the flash memory is always expensive and has serious shortage in supply, most firms requiring flash memory have to undertake high cost for the flash memory and the risk of shutdown due to shortage of available flash memory.

Moreover, flash memory is rather a storage device than a general RAM because data stored in the flash memory would not loss when a computer is shut down. The flash memory reads data at a speed similar to a general RAM. However, when it is desired to write data into the flash memory, it is necessary to erase the existed data first. Therefore, as another disadvantage of the flash memory, it requires longer time to write data. In conclusion, while the USB is an interface enabling high-speed transmission of data, the flash memory has a much slower data access speed that is only about 10% of the transmission speed provided by USB 2.0 to result in a relatively poor operating efficiency.

It is therefore tried by the inventor to develop a portable data storage device that uses a volatile memory to read, write, and access data, so as to achieve higher processing speed and enable reduced manufacturing cost.

The volatile memory is a dynamic random access memory (DRAM) or a synchronous dynamic random access memory (SDRAM).

The DRAM is currently the type of memory most widely used in computers. By main memory or SDRAM, it means a plurality of memory modules made of DRAM chips. When the computer operates, the system uses DRAM to store temporary data, programs, and various kinds of information used in the process of operation. These data, programs, and information are either stored in or read by the central processing unit (CPU), display card, and other peripherals. We call this type of memory as DRAM because its storage units or cells use extremely tiny capacitors to store charges, and these extremely tiny capacitors must be charged within a period of time to maintain an initial voltage. Whenever the computer reads the data at the address of a bit once, the bit is charged once without the need of additional charging circuit. The movement of charging the bit is referred to as refresh, which is a unique feature of DRAM. It is the unique feature of refresh that makes DRAM have lower cost. The SDRAM employs almost the same principle as the DRAM, except that SDRAM may synchronize with CPU clock to avoid time delay and thereby increase the access efficiency of the memory. Therefore, when a DRAM or a SDRAM is associated with the USB 2.0 to transmit data, a highly efficient data transmission may be achieved.

### SUMMARY OF THE INVENTION

A primary object of the present invention is to provide a portable data storage device that uses a volatile memory to read, write, and store data and can therefore have lower manufacturing cost and provide faster data processing speed.

To achieve the above and other objects, the portable data storage device according to the present invention mainly includes a universal serial bus (USB) connector; a volatile memory for reading, writing, and storing data; a control chip connected between the USB connector and the volatile memory for serving as a transmission interface with an external electronic apparatus; a charging battery for providing power needed by the volatile memory to store data; and a battery charging circuit connected between the USB connector and the charging battery for charging the charging battery.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow diagram showing the operation of the portable data storage device of the present invention; and

FIG. 2 is a flow diagram showing the operation of a control chip included in the portable data storage device of FIG. 1.

### DETAILED DESCRIPTION OF THE PREFERRED EMBODIMENTS

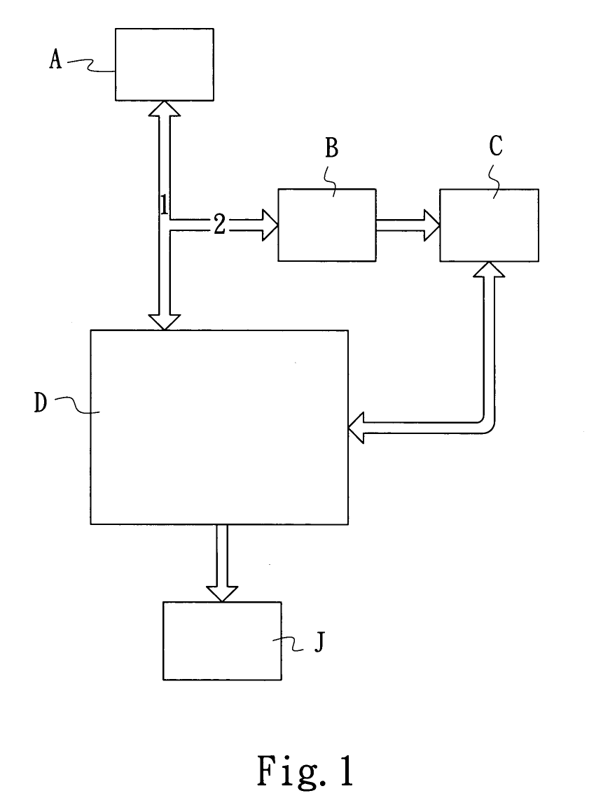

Please refer to FIG. 1 that is a flow diagram showing the operation of a portable data storage device according to the present invention. As shown, the portable data storage device mainly includes a universal serial bus (USB) connector 1, a volatile memory J, a control chip D, a battery charging circuit B, and a charging battery C.

The volatile memory J may be a DRAM or a SDRAM. Since the DRAM and the SDRAM are not expensive and may match the transmission rate of USB 2.0, the portable data storage device of the present invention using any one of them as the memory may have increased processing speed and reduced manufacturing cost.

The USB connector 1 is connected to an external electronic apparatus A to perform data transmission. Data are processed by the control chip D and then stored in the volatile memory J. The battery charging circuit B is connected between a 5V power supply 2 of the USB and the charging battery C to charge the charging battery C and enables the latter to supply power required for the volatile memory J to maintain data storage.

The external electronic apparatus A may be a computer, a digital camera, a digital video camera, a mobile phone, a personal digital assistant, a printer, or an electronic calculator.

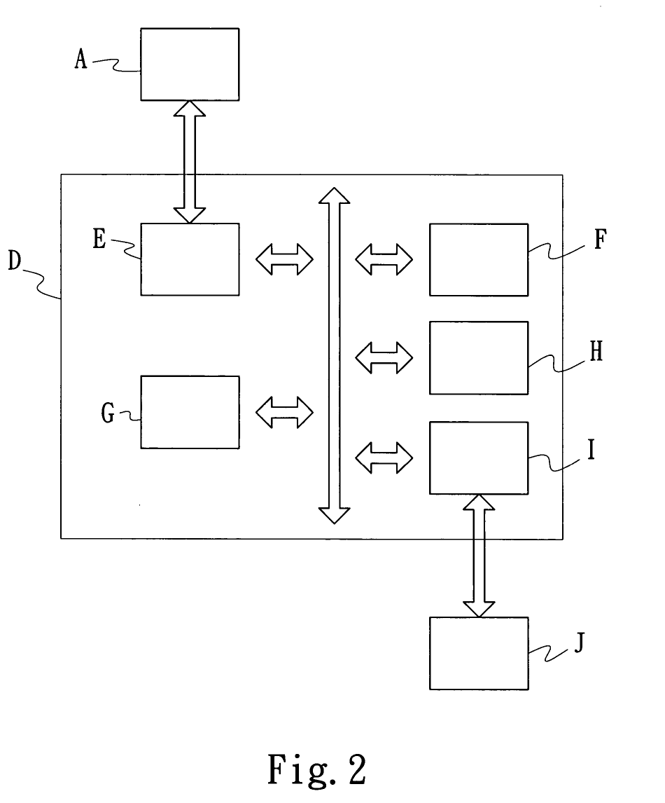

FIG. 2 is a flow diagram showing the operation of the control chip D in the portable data storage device of the present invention. As shown, the control chip D includes a USB serial interface engine (USB SIE) E, a micro processing unit F, a firmware unit G, a program RAM H, and a RAM memory module I. The USB SIE E is connected to the USB connector 1. In writing data, data stored in the external electronic apparatus A are sent to the control chip D via the USB SIE E. Data sent to the control chip D are then operated and processed by the micro processing unit F, the firmware unit G, the program RAM H, and the RAM memory module I, and written to the volatile memory J for storage.

The micro processing unit F is similar to a central processing unit (CPU) of a computer and is adapted to operate data, control data flow direction, and distribute resources. The firmware unit G consists of a plurality of instructions to command the micro processing unit F to do various work. The program RAM H serves as a data buffer to provide the function of temporarily storing data. The RAM memory module transmits data to the volatile memory J for storage.

The use of a volatile memory J to store data not only overcomes the problem of high cost for the conventional flash memory, but also upgrades the whole working speed of the portable storage device to provide a highly increased operating efficiency.

In using the USB to charge, only two types of charging rates, namely, 100 mA and 500 mA, are supported due to a limit by the specification of the USB. In the present invention, a charging battery that is charged via a USB is employed to provide power needed by the DRAM or the SDRAM to store data. Therefore, the portable data storage device of the present invention provides even faster processing speed and requires only a reduced cost.

1. A portable data storage device, comprising:
a universal serial bus (USB) connector;
a volatile memory for read and write and store data;
a control chip connected between said USB connector and said volatile memory to serve as a transmission interface between said portable data storage and an external electronic apparatus;
a charging battery for providing power needed by said volatile memory to store data; and
a battery charging circuit connected between said USB connector and said charging battery for charging said charging battery.

2. The portable data storage device as claimed in claim 1, wherein said USB connector comprises a USB version 2.0.

3. The portable data storage device as claimed in claim 1, wherein said volatile memory comprises a dynamic random access memory (DRAM).

4. The portable data storage device as claimed in claim 1, wherein said volatile memory comprises a synchronous dynamic random access memory (SDRAM).

5. The portable data storage device as claimed in claim 1, wherein said control chip includes a USB serial interface engine, a micro processing unit, a firmware unit, a program RAM, and a RAM memory module.

6. The portable data storage device as claimed in claim 1, wherein said external electronic apparatus is selected from the group consisting of computer, digital camera, digital video camera, mobile phone, personal digital assistant, printer, and electronic calculator.

7. The portable data storage device as claimed in claim 1, wherein said charging battery is charged using power from said external electronic apparatus via said USB connector and said charging circuit.
